(19) United States
(12) Patent Application Publication
(10) Pub. No.: US 2018/0037072 A1
(43) Pub. Date: Feb. 8, 2018

(54) TIRE-GRIPPING HEAD, AND TIRE-MOUNTING/REMOVING ROBOT AND TIRE-MOUNTING/REMOVING SYSTEM WHICH INCLUDE SAME

(71) Applicant: SEAPARTS CO. LTD., Yamaguchi (JP)

(72) Inventors: Nichio YOSHIKAWA, Yamaguchi (JP); Kenji TANAKA, Yamaguchi (JP); Kohei KOMURA, Yamaguchi (JP)

(21) Appl. No.: 15/553,844

(22) PCT Filed: Feb. 26, 2016
(86) PCT No.: PCT/JP2016/055903

§ 371 Date: Aug. 25, 2017

(30) Foreign Application Priority Data
Feb. 28, 2015 (JP) 2015-039710

(51) Int. Cl. B60C 25/05; B60C 25/132

(52) U.S. Cl. CPC B60C 25/0521; B60C 25/132; B60C 25/0596

(57) ABSTRACT

There is provided a tire-mounting/removing robot capable of automatically grasping a spent or used tire in which a tire wheel is mounted, a tire-mounting/removing system in which the tire wheel can be automatically removed from and mounted in the spent or used tire in which the tire wheel is mounted by using this tire-mounting/removing robot, and a tire-gripping head used in the tire-mounting/removing robot and the tire-mounting/removing system. Hand portions that grasp a tire or a tire wheel, and mechanisms that open and close the hand portions are provided. The hand portion includes a claw portion in an end portion of the hand portion, and this claw portion includes a first claw portion to be locked onto an edge portion of a rim of the tire wheel to grasp the tire wheel or a tire wheel-mounted tire in which this tire wheel is mounted, and a second claw portion to be locked onto a bead portion of a tire wheel-non-mounted tire to grasp the tire wheel-non-mounted tire.

### TECHNICAL FIELD

The present invention relates to a tire-gripping head for removing or mounting a tire main body from or in a tire in which a tire wheel is mounted, and a tire-mounting/removing robot and a tire-mounting/removing system which include the same.

### BACKGROUND ART

In today's automobile recycling industry, shrinking of the automobile used parts market is deeply concerned, and facilitation of use of used parts is a long-term problem. In Japan. new parts are strongly preferred and used parts are mostly disposed. In particular, tires are consumables in high demand. Thus, a cycle of replacing the tire with a new one is short. Although a generation amount of unnecessary waste tires is said to be about one million tons per year, many of the waste tires are still usable. There are various methods of waste treatment. However, possibly-endocrine-disrupting chemicals generated at the time of incineration may influence an environment, and there is a fear that the environment influences human bodies.

Thus, it is thought that when a series of steps including collection of spent tires, quality management, material separation, and shipping preparation can be realized with high precision and efficiency, recycling of spent and used tires can be more facilitated.

However, the spent tires are generally collected in a state where wheels are mounted. In order to manage, ship, and distribute a tire main body and a tire wheel separately, there is a need for removing the tire wheel from the tire main body. This task requires physical energy and time more than mounting. Thus, the number of the tire wheel-mounted tires that a single worker can remove the wheels is limited, and the steps cannot be always efficient.

In order to solve such a problem, several patent applications have been filed so far.

For example, Patent Document 1 discloses a bead portion separation device capable of optimally separating a bead portion in accordance with a specific type of tire from which the bead portion is separated under the title of “bead portion separation device used in tire replacement machine, etc.”

In a state where the tire wheel-mounted tire is fixed on a table disclosed in FIG. 1 of Patent Document 1, the bead portion is removed.

Patent Document 2 also discloses a device under the title of “tire bead detaching device,” which is similar to the device disclosed in Patent Document 1. In particular, Patent Document 2 discloses the device capable of, for a tire in which an upper bead is highly closely attached to an upper rim of a wheel, easily and smoothly inserting an insertion portion of a bead detaching tool into a portion between the upper bead and the upper rim.

### PRIOR ART DOCUMENTS

### Patent Documents

Patent Document 1: JP 2014-213850 A
Patent Document 2: JP 2014-172486 A

### SUMMARY OF THE INVENTION

### Problems to be Solved by the Invention

However, with the techniques disclosed in Patent Document 1 and Patent Document 2, since the tire is fixed on a flat plate, the upper rim and the upper bead portion can be separated but a lower rim and a lower bead portion on the lower surface side facing the flat plate cannot be separated straightaway, and there is a need for unfixing the tire, turning back, and fixing again to bring the lower rim and the lower bead portion on the upper side before separating in a similar way. Thus, there is a problem that working efficiency is poor.

There is also a need for a task of placing the tires on the flat plate table one by one. Thus, there is a problem that reduction of labor and time saving for workers are not remarkable and hence physical and mental burdens of the workers cannot possibly be improved at the end.

Further, in the automobile recycling industry, management work and shipping work. etc. are already more automated with computers recently, and if a dismantling task, etc. were more automated, there would be an advantage that automation and linking of a series of work from delivery of used automobiles to shipping of recycled products such as re-used tires are facilitated. However, there is a problem that the advantage cannot be sufficiently enjoyed.

The present invention is achieved to address such conventional circumstances, and an object thereof is to provide a tire-mounting/removing robot capable of automatically grasping a spent or used tire in which a tire wheel is mounted or the tire wheel, a tire-mounting/removing system in which the tire wheel can be automatically removed from the spent or used tire in which the tire wheel is mounted or conversely mounted by using this tire-mounting/removing robot, and a tire-gripping head used in the tire-mounting/removing robot and the tire-mounting/removing system.

### Solutions to the Problems

In order to achieve the above object, a tire-gripping head of the invention according to claim 1 includes a hand portion that grips a tire or a tire wheel, and a mechanism that opens and closes the hand portion, wherein the hand portion includes a claw portion in an end portion of the hand portion, and the claw portion includes a first claw portion to be locked onto an edge portion of a rim of the tire wheel to grasp the tire wheel or a tire wheel-mounted tire in which the tire wheel is mounted, and a second claw portion to be locked onto a bead portion of a tire wheel-non-mounted tire to grasp the tire wheel-non-mounted tire.

In the tire-gripping head of the above configuration, the hand portion with the opening and closing mechanism includes the claw portion, and furthermore, the claw portion includes the first claw portion to be locked onto the edge portion of the rim of the tire wheel to grasp the tire wheel or the tire wheel-mounted tire, and the second claw portion to be locked onto the bead portion of the tire wheel-non-mounted tire to grasp the tire wheel-non-mounted tire. Thereby, the tire-gripping head is operated to grasp both the tire in which the tire wheel is mounted, and the tire in which the tire wheel is not mounted. Further, the first claw portion is locked onto the edge portion of the rim of the tire wheel to grasp the tire wheel. Thus, the tire-gripping head is also operated to grasp the tire wheel main body after the tire main body is removed.

Therefore, the tire-gripping head is operated in such a manner that for the spent or used tire in which the tire wheel is mounted, the tire main body is removed while grasping the tire by the first claw portion, the tire wheel is moved to, released, and mounted on a desired place while grasping the tire wheel, and then the removed tire main body is grasped by the second claw portion. The tire-gripping head can also be used at the time of mounting the tire wheel in the tire or at the time of grasping the tire wheel and moving to a position of a tire in which a tire wheel is not mounted, etc.

When a term “tire” is simply used in the present application, the term indicates both the tire in which the tire wheel is already mounted, and the tire in which the tire wheel is not mounted. Grasping of the tire wheel-mounted tire by the first claw portion indicates that the first claw portion is locked onto the edge portion of the rim of the tire wheel mounted in the tire wheel-mounted tire to grasp the tire wheel-mounted tire.

The tire-gripping head of the invention according to claim 2 is characterized in that, in the tire-gripping head according to claim 1, the mechanism that opens and closes the hand portion includes a screw shaft, a nut to be screwed onto the screw shaft, a first pulley provided in the screw shaft, a belt looped over the first pulley, a second pulley over which the belt is looped, and a drive motor that turns the second pulley, the hand portion is engaged with the nut, and the hand portion is opened and closed by movement of the nut in accordance with rotation of the screw shaft.

In the tire-gripping head of the above configuration, in addition to the operations of the invention according to claim 1, the mechanism that opens and closes the hand portion is operated to transmit drive force of the drive motor to the screw shaft via the second pulley, the belt, and the first pulley by rotation of the drive motor.

By rotation of the screw shaft to which the drive force of the drive motor is transmitted, the nut is linearly moved and the hand portion engaged with this nut is operated to be opened and closed.

In a tire-mounting/removing robot of the invention according to claim 3, the tire-gripping head according to claim 1 or 2 is mounted in a leading end of an arm.

In the tire-mounting/removing robot of the above configuration, the hand portion according to claim 1 or 2 is mounted in the leading end of the arm. Thus, in a moving destination of the arm, the respective operations of the tire-gripping head are exerted.

Further, a tire-mounting/removing system of the invention according to claim 4 includes the tire-mounting/removing robot according to claim 3, and a tire-mounting/removing jig for removing the tire wheel from the tire wheel-mounted tire, wherein the tire-mounting/removing jig has a first insertion tool to be inserted into a gap between the rim of the tire wheel of the tire wheel-mounted tire and the bead portion of the tire to separate the rim and the bead portion in a state where the first claw portion of the hand portion is put into the gap between the rim and the bead portion of the tire and locked onto the edge portion of the rim and the hand portion grasps the tire wheel-mounted tire, and a second insertion tool to be inserted into the gap between the rim and the bead portion which are separated by the first insertion tool to bring the bead portion of the tire arranged on an inner side of the rim of the tire wheel over the rim of the tire wheel and remove the bead portion to an outer side of the rim.

In the tire-mounting/removing system of the above configuration, the first claw portion of the tire-gripping hand of the tire-mounting/removing robot is operated to be locked onto the edge portion of the front or back side rim of the tire wheel to grasp the tire wheel-mounted tire, and in that state, the first insertion tool is operated to be inserted into the gap between the front or back side rim of the tire wheel and the bead portion of the tire to separate the rim and the bead portion.

After that, the second insertion tool is operated to be inserted into the gap between the separated rim and the separated bead portion. Further, the tire-mounting/removing robot is operated to pull the tire wheel-mounted tire to bring away from the second insertion tool, and operated to bring the bead portion of the tire arranged on the inner side of the rim of the tire wheel over the rim of the tire wheel and remove the bead portion to an outer side of the rim.

Further, with the tire-mounting/removing system, since the first claw portion of the tire-gripping head remains locked onto the edge portion of the rim, the removed tire wheel is operated to be grasped by the first claw portion continuously.

In the present application, regarding the front and the back of the tire wheel, the side of the tire wheel exposed normally at the time of driving the automobile is referred to as the front side, and the side of the non-exposed tire wheel is referred to as the back side.

A tire-mounting/removing system of the invention according to claim 5 is characterized in that, in the tire-mounting/removing system of the invention according to claim 4, the tire-mounting/removing robot pushes a rim on an opposite side to a side where the first claw portion grasps the tire wheel into the bead portion on one side of the tire wheel-non-mounted tire in a state where the first claw portion of the hand portion is locked onto the edge portion of the rim of the tire wheel to grasp the tire wheel, and the first insertion tool, by inserting a bead portion on the other side of the tire wheel-non-mounted tire into the inner side of the rim on the opposite side, mounts the tire wheel in the tire wheel-non-mounted tire.

In the tire-mounting/removing system of the above configuration, the tire-mounting/removing robot is operated to grasp and push the tire wheel into the tire wheel-non-mounted tire, and the bead portion opposite to the side where the first insertion tool is pushed in is operated to be inserted into the rim of the tire wheel on the inner side of the tire.

A tire-mounting/removing system of the invention according to claim 6 is characterized in that, in the tire-mounting/removing system according to claim 4 or 5, a water injection port is provided in the vicinity of at least one of the first insertion tool and the second insertion tool, and water or a surfactant aqueous solution is injectable when the first insertion tool or the second insertion tool is inserted into the gap between the rim of the tire wheel and the bead portion of the tire.

In the tire-mounting/removing system of the above configuration, the water injection port is operated to inject water or a surfactant aqueous solution to the first insertion tool or the second insertion tool, or the rim of the tire wheel or the bead portion of the tire, or a gap therebetween.

The water injection port is a concept including a simply opening shape, a nozzle shape, and a configuration including a header.

A tire-mounting/removing system of the invention according to claim 7 is characterized in that, in the tire-mounting/removing system according to any one of claims 4 to 6, a removed tire storage shed on which the removed tire is mountable is provided in the vicinity of the first insertion tool or the second insertion tool.

The tire-mounting/removing system of the above configuration is operated in such a manner that the tire main body removed by the second insertion tool is temporarily placed in the removed tire storage shed.

### Effects of the Invention

With the tire-gripping head according to claim 1 of the present invention, by including the first claw portion and the second claw portion, both the tire in which the tire wheel is mounted, and the tire in which the tire wheel is not mounted can be grasped. Furthermore, the first claw portion is locked onto the edge portion of the rim of the tire wheel in the tire in which the tire wheel is mounted. Thus, the tire wheel main body can be continuously grasped at the time of removing the tire wheel from the spent or used tire and at the time of mounting the tire wheel in the tire. Further, the second claw portion is locked onto the bead portion of the tire. Thus, the tire main body removed from the tire wheel and the tire main body before the tire wheel is mounted can also be grasped.

That is, regarding the spent or used tire, any of the tire wheel-mounted tire, the tire wheel main body, and the tire main body (tire wheel-non-mounted tire) can be grasped even in any step before and after removal of the tire wheel or in a step of mounting the tire wheel in the tire. Thus, the tire-gripping head can be utilized in all the steps of a task of mounting/removing the tire wheel of the spent or used tire.

With the tire-gripping head according to claim 2 of the present invention, the same effects as the effects of the invention according to claim 1 can also be exerted.

With the tire-mounting/removing robot according to claim 3 of the present invention, the effects that the tire-gripping head according to claim 1 or 2 can exert can be exerted within an operation range of the provided arm.

With the tire-mounting/removing system according to claim 4 of the present invention, the tire-gripping head can grasp the tire wheel-mounted tire. By including the tire-mounting/removing robot including such a tire-gripping head and the tire-mounting/removing jig, while keeping the tire-mounting/removing jig in a stationary state, the tire main body and the tire wheel can be automatically removed from the tire wheel-mounted tire by utilizing movement of the tire-mounting/removing robot.

The removed tire wheel remains locked by the tire-gripping head, and hence can be moved to a desired place by the tire-mounting/removing robot straightaway, and can also be released and arranged at the desired place.

Further, the removed tire main body can also be grasped by the second claw portion of the tire-gripping head. Thus, the tire main body can also be moved to a desired place by the tire-mounting/removing robot, and can also be arranged at the desired place.

With the tire-mounting/removing system according to claim 5 of the present invention, in addition to the effects of the tire-mounting/removing system according to claim 4, the tire wheel can be easily mounted in the tire wheel-non-mounted tire.

With the tire-mounting/removing system according to claim 6 of the present invention, in addition to the effects of the tire-mounting/removing system according to claim 4 or 5, since water or a surfactant aqueous solution is injectable by the water injection port, a coefficient of friction generated between the first insertion tool and the second insertion tool or the tire wheel and the bead portion of the tire can be reduced. Thus, a task of mounting/removing can be easily performed, so that damage, etc. to the tire by friction force (heat) can be prevented.

With the tire-mounting/removing system according to claim 7 of the present invention, in addition to the effects to be exerted by the invention according to any one of claims 4 to 6, the tire main body removed from the tire wheel can be temporarily placed.

### BRIEF DESCRIPTION OF THE DRAWINGS

FIG. 1 is a configuration diagram of a tire-mounting/removing robot according to a first embodiment of the present invention, and a tire-mounting/removing system according to a second embodiment including this tire-mounting/removing robot and a mounting/removing jig.

FIG. 2(a) is a structure diagram showing a state where a gripping hand of a tire-gripping head according to a third embodiment of the present invention is closed.

FIG. 2(b) is a structure diagram showing a state where the gripping hand of the tire-gripping head according to the third embodiment of the present invention is opened.

FIG. 3(a) is a concept view for illustrating a state where a rim of a wheel is locked by a first claw portion of the tire-gripping head according to the third embodiment of the present invention.

FIG. 3(b) is a concept view for illustrating a state where a bead portion of a tire is similarly locked by a second claw portion.

FIG. 4 is a concept view showing a state where a head of the tire-mounting/removing system according to the second embodiment of the present invention grasps the tire.

FIG. 5 is a concept view showing a state where the rim of the back side wheel and the bead portion of the tire are separated by an insertion tool of the mounting/removing jig of the tire-mounting/removing system according to the second embodiment of the present invention.

FIG. 6 is a concept view showing a state where the rim of the front side wheel and the bead portion of the tire are separated by an insertion tool of the mounting/removing jig of the tire-mounting/removing system according to the second embodiment of the present invention.

FIG. 7 is a concept view for illustrating a state where the bead portion of the tire is brought over the rim of the front side wheel to be removed to the outer side by the insertion tool of the mounting/removing jig of the tire-mounting/removing system according to the second embodiment of the present invention.

FIG. 8 is a concept view for illustrating a state where the bead portion of the tire on the side of the back side wheel is removed from the rim of the front side tire by the insertion tool of the mounting/removing jig of the tire-mounting/removing system according to the second embodiment of the present invention.

FIG. 9 is a concept view for illustrating a state where the bead portion of the tire is brought over the rim of the front side wheel to the inner side to be mounted by the insertion tool of the mounting/removing jig of the tire-mounting/removing system according to the second embodiment of the present invention.

FIG. 10 is a summary view for illustrating removing actions of the tire-mounting/removing system according to the second embodiment of the present invention.

FIG. 11 is a summary view for illustrating mounting actions of the tire-mounting/removing system according to the second embodiment of the present invention.

### EMBODIMENTS OF THE INVENTION

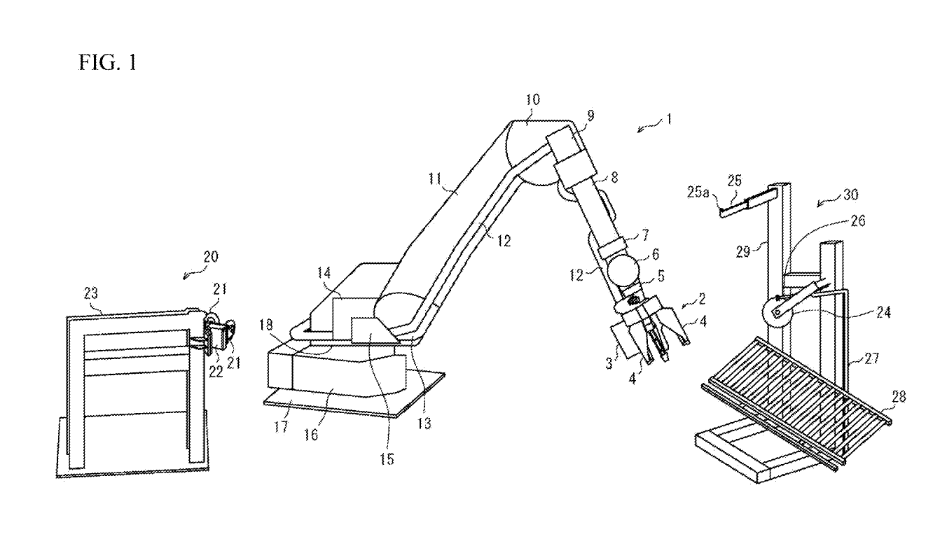

Hereinafter, a tire-mounting/removing robot according to a first embodiment of the present invention and a tire-mounting/removing system will be described with reference to FIG. 1.

FIG. 1 is a configuration diagram of the tire-mounting/removing robot according to the first embodiment of the present invention, and a tire-mounting/removing system according to a second embodiment including this tire-mounting/removing robot and a mounting/removing jig.

In FIG. 1, a tire-mounting/removing robot 1 is fixed on a base 17, and a motor 16 that drives a first joint 18 forming the yaw axis is installed on the bottommost portion.

The tire-mounting/removing robot 1 includes a first arm 11 and a second arm 8, and a tire-gripping head 2 serving as an end effecter is provided in an end portion of the second arm 8.

The first arm 11 includes a second joint 13 forming the pitch axis so as to be pivoted forward and backward. The first arm is connected to the second arm 8 via a third joint 10 similarly forming the pitch axis, and the second arm 8 can be pivoted forward and backward by this third joint 10.

Further, the second arm 8 includes a fourth joint 7 forming the roll axis, and this fourth joint 7 can be driven by a motor 9. The second arm also includes a fifth joint 6 forming the pitch axis in a portion ranging from the fourth joint 7 to the end portion of the second arm 8, and further includes a sixth joint 5 forming the roll axis. Description of motors that drive these joints will be omitted here. However, the fourth joint 7, the fifth joint 6, and the sixth joint 5 set on the second arm 8 can be driven independently from each other.

The head 2 is provided in the end portion of the second arm 8 as described above. In this head 2, gripping hands 4 to be driven by a motor 3 for grasping a tire are provided.

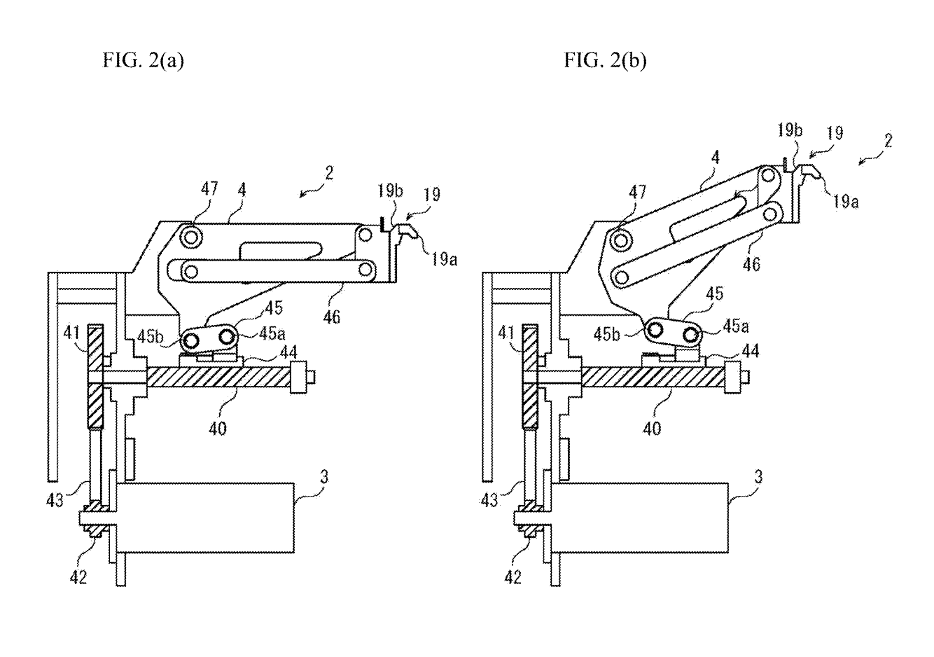

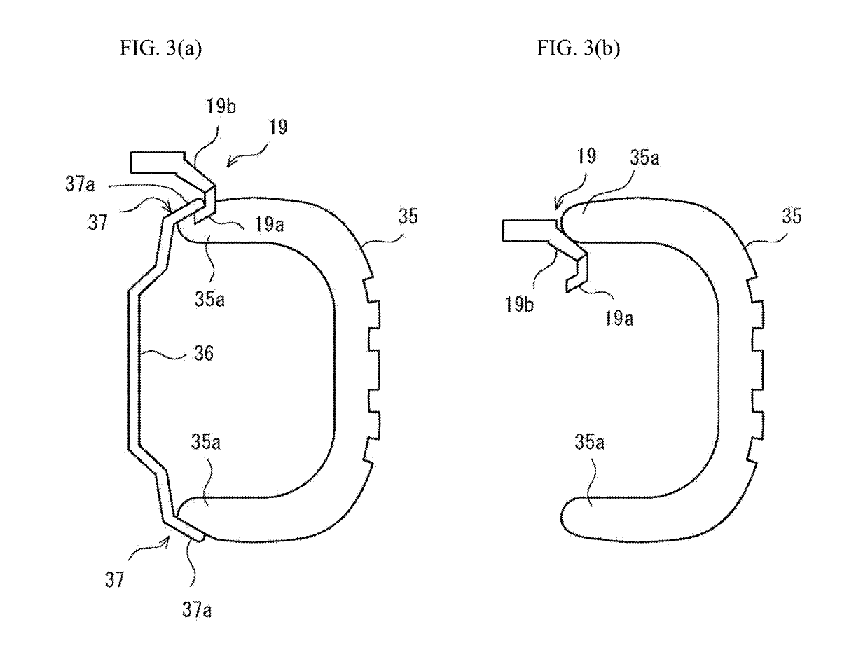

Details of the head 2 will be described later with reference to FIGS. 2, 3 as a third embodiment according to the present invention.

The tire-mounting/removing robot 1 according to the first embodiment includes the six axes as described above apart from the actuation axis of the head 2, and is driven by respectively controlling servomotors. An encoder 14 is provided in the tire-mounting/removing robot 1. While rotation angles of the motors that drive the respective joints forming the six axes are received as digital signals and angles of the joints are detected by the digital signals, the posture is controlled. From a power source terminal 15 for supplying electric power to the motor 9 used for roll rotation of the second arm 8, the drive motor 3 of the head 2, etc., a power source and signal cable 12 is connected to the motor 3 of the head 2 in the end portion via the first arm 11 and the second arm 8.

By including the head 2 for grasping the tire, the tire-mounting/removing robot 1 formed in such a way can grasp the tire, etc. on all aspects of a task of mounting/removing the tire such as a tire wheel-mounted tire, a wheel main body, and a tire main body (tire wheel-non-mounted tire).

Furthermore, since the head 2 is installed as the end effecter of the six-axis-controlled robot, the head 2 can be freely moved within a range where the first arm 11 and the second arm 8 of the tire-mounting/removing robot 1 can reach to grip the tire.

Even after the tire is grasped, the head can be freely moved.

Further, by providing the head 2 in a leading end of the arm of the robot, the mounting/removing jig can access the front and the back of the wheel. A task can be performed from any of a front surface and a back surface of the wheel. There is also no need for grasping the wheel again to change the front and the back and tasks from the front side and the back side can be continuously executed. The head 2 can grasp from any of the front and the back of the wheel.

Next, with reference to the same FIG. 1, the tire-mounting/removing system according to the second embodiment will be described.

In FIG. 1, the tire-mounting/removing system includes a mounting/removing jig 20 and a mounting/removing jig 30 in addition to the tire-mounting/removing robot 1. The mounting/removing jig 20 includes flat disc shaped insertion tools 21, 21 fixed to a support plate 22 which is provided in a mount 23, and the mounting/removing jig 30 includes a flat disc shaped insertion tool 24 provided in a mount 29, a flat-plate and long-rod shaped insertion tool 25 having a hook 25a in a leading end, a water injection pipe 27 including a jetting nozzle 26 provided in the vicinity of the insertion tool 24, and further, a removed tire storage shed 28 for temporarily placing the removed tire.

Among these configurations, the insertion tools 21, the insertion tool 24, and the insertion tool 25 play particularly important roles. Among the insertion tools, the flat disc shaped insertion tools 21, 24 have a function of separating pressure bonding between the rim and a bead portion of the tire by being inserted into a gap between the rim of the wheel and the tire and rotating the head 2 which is grasping the tire. This separation of the pressure bonding between the rim and the bead portion of the tire is implemented on both the front and the back of the wheel.

By pressing the tire by the head 2, the insertion tool 25 is inserted from a gap between the rim and the tire which are separated by the insertion tools 21, 24. By catching part of the tire with the hook 25a of the insertion tool 25 and rotating the head 2 in a catching state, the bead portion of the tire is brought over the rim of the wheel to be removed to the outer side.

The insertion tools 21, 21 are provided in pairs to be arranged to separate the rim and the bead portion from the front side and then continuously separate the back side rim and the bead portion corresponding to the front and the back of the wheel.

Next, for the tire, it is difficult to bring the bead portions on both the sides over the rim on the same side only by the insertion tool 25. Thus, in a state where the bead portion on one side is brought over the rim by using the insertion tool 25, the bead portion on the other side is pressed from the opposite side by using the flat disc shaped insertion tool 24 again to be removed from the rim on the same side. Thereby, the tire main body can be completely removed.

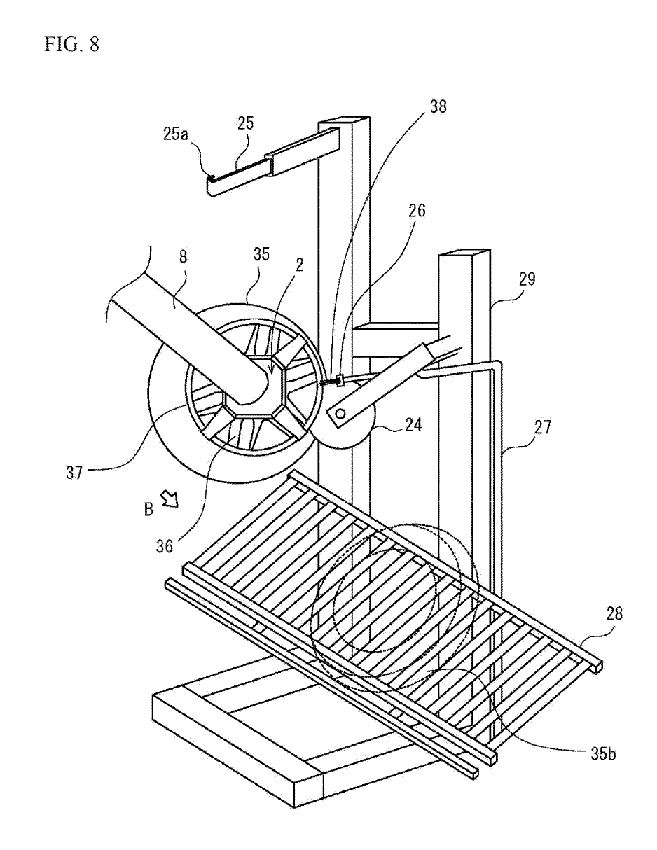

As shown in FIG. 1, in the configuration of the tire-mounting/removing system, the insertion tool 24 is formed in a flat disc shape which is similar to the insertion tools 21, 21. However, the insertion tool 24 is provided in the vicinity of the insertion tool 25, so as to serve for bringing the one side bead portion over the rim by using the insertion tool 25 and then immediately bringing the other side bead portion over the same side rim. A step of pressing the other side bead portion from the opposite side by using this insertion tool 24 and bringing the bead portion over the same side rim over which the first one side bead portion is brought to remove the tire will be described later with reference to FIG. 8.

Further, the jetting nozzle 26 is arranged in the vicinity of the insertion tool 24. This is to release water or a surfactant aqueous solution via the water injection pipe 27 to reduce friction between the insertion tool 24 which is actuated in the gap between the rim of the wheel and the bead portion of the tire, and the rim and the bead portion, so as to suppress generation of friction heat, and to prevent damage to these portions by heat and friction. In the present embodiment, the jetting nozzle 26 is provided in the vicinity of the insertion tool 24. However, such a jetting nozzle 26 may be provided in the vicinity of any of the insertion tools 21, 21 and the insertion tool 25, or may be provided in the vicinity of all the insertion tools 21, 24, 25.

Except for the jetting nozzle 26, a simple opening, a nozzle injecting water or a surfactant aqueous solution in a misty manner, or a header to release water or a surfactant aqueous solution from plural points may be provided. A diameter thereof may be appropriately adjusted in order to ensure a flow rate suitable for the above purposes.

The removed tire storage shed 28 is provided in the mounting/removing jig 30. This is to receive and temporarily place the drop-off tire when the tire main body is eventually completely removed from the wheel by the insertion tool 25 or the insertion tool 24. In the present embodiment, the removed tire storage shed is formed in a ladder shape but may be formed in a flat plate shape or a box shape. As long as the temporarily placed tire main body can be grasped again for moving, etc. and space efficiency is favorable, the shape, etc. of the removed tire storage shed is not limited.

Before describing actions of the tire-mounting/removing system according to the second embodiment, the tire-gripping head according to the third embodiment of the present invention will be described with reference to FIGS. 2 and 3.

FIG. 2(a) is a structure diagram showing a state where the gripping hand of the tire-gripping head according to the third embodiment of the present invention is closed. FIG. 2(b) is a structure diagram showing a state where the gripping hand of the tire-gripping head according to the third embodiment of the present invention is opened. With reference to FIG. 2, actions of opening and closing the head 2 will be described. In FIG. 2, for simplifying the description, although the tire-gripping head is supposed to include four gripping hands 4, one of the gripping hands is shown and the actions will be described.

In FIG. 2(a), the gripping hand 4 of the head 2 includes a claw portion 19 in an end portion thereof. The claw portion 19 includes a first claw portion 19a provided in a tip end portion, and a second claw portion 19b in a root portion thereof.

The gripping hand 4 is driven by the motor 3. When the motor 3 is turned, a drive side timing pulley 42 is turned and a timing belt 43 looped over the drive side timing pulley 42 is turned, so that a driven side timing pulley 41 is activated. Since the driven side timing pulley 41 is fixed to a driving screw 40 provided with a trapezoidal thread, the driving screw 40 is turned. By turning this driving screw 40 as a feed screw, a nut 44 screwed on this driving screw 40 can be linearly moved.

FIG. 2(b) shows the state where the nut 44 is linearly moved in the right direction from the state of FIG. 2(a). A linear movement coupling link plate 45 is fixed to the nut 44 pivotably by a shaft 45a. The gripping hand 4 is fixed to this linear movement coupling link plate 45 pivotably via a shaft 45b. Therefore, in accordance with linear movement of the nut 44, the gripping hand 4 is pivoted centered on an open/close shaft 47 pivotably supporting the gripping hand 4. As a result, the four gripping hands 4 make an opening action centered on the driving screw 40. At this time, a parallel link bar 46 is operated to be maintained in parallel to a side of the gripping hand 4. Thus, while the claw portion 19 is maintained in parallel to a surface of the tire or the wheel, an opening operation can be performed.

As a matter of course, the state of FIG. 2(b) can be brought into the state of FIG. 2(a) by conversely turning the motor 3. The electric power is supplied to the motor 3 via the power source and signal cable 12 described above. An angle of this motor 3 is detected by the encoder 14. Similarly, opening and closing actions of the head 2 are controlled by a signal received by the encoder 14.

Next, with reference to FIG. 3, a state where this tire-gripping head grasps the wheel-mounted tire and a state where the tire-gripping head grasps the tire main body when the wheel is removed will be described. FIG. 3(a) is a concept view for illustrating a state where the rim of the wheel is locked by the first claw portion of the tire-gripping head according to the third embodiment of the present invention. FIG. 3(b) is a concept view for illustrating a state where the bead portion of the tire is similarly locked by the second claw portion.

In FIG. 3(a), at the time of grasping a tire 35 in which a wheel 36 is mounted, firstly, the first claw portion 19a is inserted into a gap between a rim 37 of the wheel 36 and a bead portion 35a of the tire 35, and the first claw portion 19a is locked onto an edge portion 37a of the rim 37. By pulling the claw portion 19 up in this state, the tire 35 is brought up while being grasped.

Meanwhile, in FIG. 3(b), in a case where the wheel 36 is removed from the tire 35, the tire 35 cannot be locked by the first claw portion 19a. Thus, the second claw portion 19b is formed continuously in the root portion of the part of the claw portion 19 where the first claw portion 19a is provided. By locking the bead portion 35a of the tire 35 on an outer-side shoulder portion of the second claw portion 19b, the tire 35 can be grasped. By similarly pulling the claw portion 19 up in this state, the tire 35 is brought up while being grasped.

Further, as described with FIG. 3(a), the first claw portion 19a is locked onto the edge portion 37a of the rim 37 of the wheel 36. Thus, the first claw portion 19a can grasp a main body of the wheel 36 after the tire 35 is removed.

Therefore, the tire-gripping head according to the third embodiment can easily grasp not only the tire 35 in which the wheel 36 is mounted but also in a case of only the main body of the wheel 36 or only a main body of the removed tire 35 (tire wheel-non-mounted tire), and can be utilized in any step of steps of removing and mounting tasks of the spent or used tire, so that the tasks can be efficiently executed.

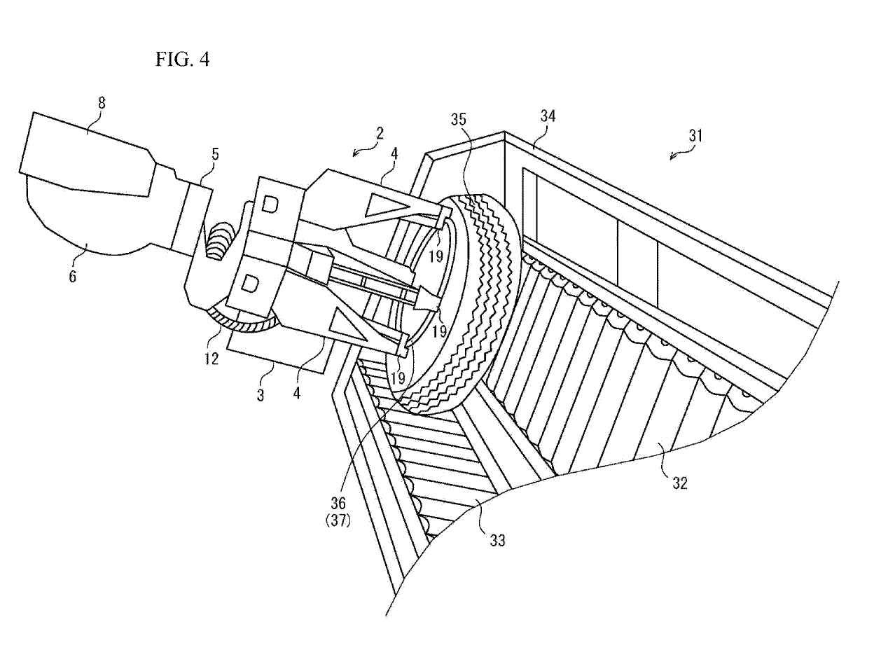

Next, with reference to FIGS. 4 to 9, the actions of the tire-mounting/removing system according to the second embodiment will be described. This tire-mounting/removing system is to automatically perform a series of tasks including a removing task of grasping the spent or used tire by itself, then removing the wheel from the tire by using the insertion tools and moving the tire and the wheel respectively, and placing at desired places, and a mounting task of grasping the wheel main body, then putting the tire main body on the wheel main body, and further, mounting the tire in the wheel by using the insertion tools.

FIG. 4 is a concept view showing a state where the head of the tire-mounting/removing system according to the second embodiment of the present invention grasps the tire.

In FIG. 4, the tire-mounting/removing robot 1 of the tire-mounting/removing system firstly grasps the spent or used tire 35 placed in a treatment tire storage shed 31 by the four gripping hands 4 provided in the head 2. At the time, by locking the claw portions 19 provided in the respective end portions of the four gripping hands 4 onto the rim 37 of the wheel 36, the tire can be strongly grasped.

This action of the gripping hands 4 can be performed by turning the motor 3 as described above. The posture of the head 2 can be controlled by using the sixth joint 5 and the fifth joint 6 provided in the second arm 8 as a matter of course, or the other joints. As described above, information relating to rotation angles of the servomotors that activate these joints is received by the encoder 14 and the servomotors are controlled.

A mount 34 of the treatment tire storage shed 31 is provided so as to be inclined with a position of the tire 35 described in the figure as the lowest portion. Thus, the tire 35 can be automatically and easily moved to the lowest position by a side surface roller 32 and a bottom surface roller 33.

In such a way, the tire 35 in which the wheel 36 is mounted is grasped. In the present embodiment, the tire 35 is arranged toward the back side of the wheel 36.

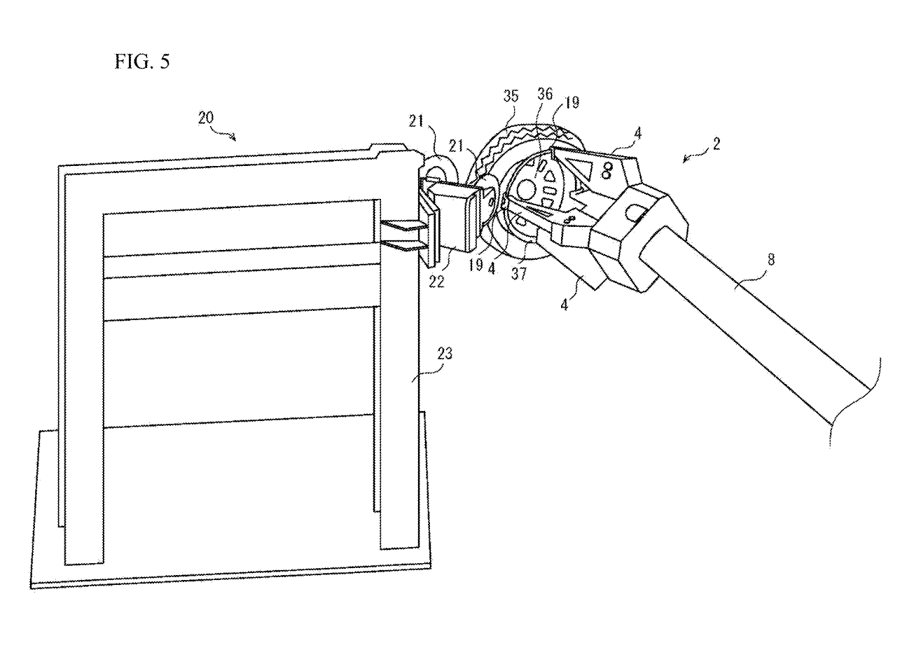

FIG. 5 is a concept view showing a state where the rim of the back side wheel and the bead portion of the tire are separated by the insertion tool of the mounting/removing jig of the tire-mounting/removing system according to the second embodiment of the present invention. As described with reference to FIG. 4, after the tire 35 in which the wheel 36 is mounted is grasped from the back side, the tire-mounting/removing system activates the second arm 8 to move the tire 35 to a place where the insertion tool 21 of the mounting/removing jig 20 is arranged, and moves the head 2 in such a manner that the insertion tool 21 is inserted into the gap between the rim 37 of the wheel 36 and the tire 35 from the back side.

Once the insertion tool 21 is inserted into the gap between the rim 37 and the tire 35, the head 2 turns the gripping hands 4 in the circumferential direction with respect to the axis of the second arm 8 to turn the tire 35. Since the claw portions 19 in the end portions of the gripping hands 4 are locked onto the rim 37, there is a possibility that the claw portions 19 may interfere with the insertion tool 21. However, by applying force in such a manner that the head 2 pulls the rim 37, the insertion tool 21 can be operated to press the tire 35 side of the claw portion 19 to suppress the interference.

In the present embodiment, the insertion tool 21 is fixed to the mount 23 via the support plate 22. However, by providing a movable range for the support plate 22, that is, providing so-called “play,” a rotating action and a pulling action of the gripping hands 4 by the head 2 can be more smoothly executed. Specific “play” is thought to have a structure in which the insertion tool 21 can be slightly moved in the horizontal direction in FIG. 5.

By making at least one turn of the gripping hands 4, pressure bonding between the rim 37 and the bead portion 35a can be separated. However, depending on a degree of separation, the gripping hands 4 may be turned for several times or may be programmed in advance so that forward and backward turning is repeated for several times.

Next, although the insertion tool 21 is now applied from the back side and the tire 35 is rotated, after the pressure bonding between the back side rim 37 and the bead portion 35a is separated, pressure bonding between the front side rim 37 and the bead portion 35a is similarly separated. In a case of the front side, separation can be performed by using the insertion tool 21 positioned on the far side in FIG. 5 of the insertion tool 21 which is now shown in FIG. 5 in a state of performing a separating task.

The insertion tool 21 is inserted into the gap between the front side rim 37 and the tire 35, and similarly the gripping hands 4 of the head 2 are turned and the pressure bonding between the rim 37 and the bead portion 35a is separated.

Although the tire 35 in which the wheel 36 is mounted is grasped from the back side in the present embodiment, the tire may be grasped from the front side conversely. However, the tire is pulled out by inserting the insertion tool 25 into a portion called a well which is the deepest portion on the rotation center side of the wheel 36 and catching and pulling part of the tire such as the bead portion 35a with the hook 25a as described above. Thus, in order to deeply insert into the well generally and often placed on the front side of the wheel 36, when the insertion tool 25 is inserted from the back side where the well is not placed, the tire 35 is more easily caught and tensile force applied to the tire at the time of pulling by the head can be decreased. That is, a load applied to the tire-mounting/removing robot 1 can be reduced.

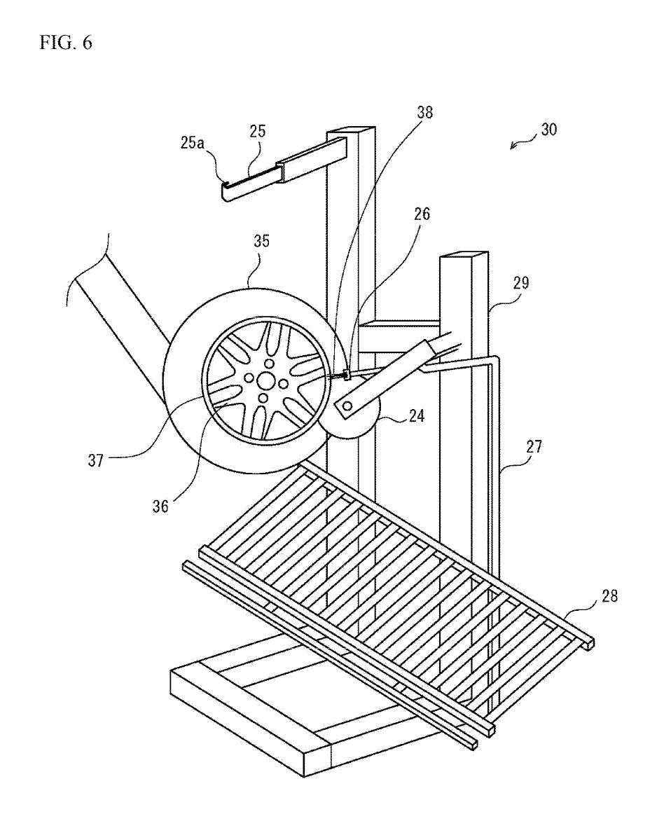

FIG. 6 is a concept view showing a state where the rim of the front side wheel and the bead portion of the tire are separated by the insertion tool of the mounting/removing jig of the tire-mounting/removing system according to the second embodiment of the present invention.

As described with reference to FIG. 5, essentially, when the pressure bonding between the rim 37 and the bead portion 35a can be separated by using the insertion tools 21 from the front side and the back side, a task shown in FIG. 6 is not required. Here, combining with description of operations of the jetting nozzle 26, a task of separating the pressure bonding between the rim 37 of the wheel 36 and the bead portion 35a of the tire 35 by using the flat disc shaped insertion tool 24 from the front side of the wheel 36 again will be described. The insertion tool 24 has the same shape and the same functions as the insertion tool denoted by the reference sign 21 but is installed in a different place.

Therefore, in the present embodiment, the insertion tools 21, 21 and the insertion tool 24 are separately provided. However, in any of a removing step and a mounting step, any one of these tools may be used, or insertion tools 21, 21 are not necessarily provided in pairs but one insertion tool 21 may be provided.

In the tire-mounting/removing system, there is sometimes a case where movement to the mounting/removing jig 20 is performed by using the tire-mounting/removing robot 1, separation of the pressure bonding between the rim 37 and the bead portion 35a is completed by the insertion tools 21, 21 from both the front side and the back side, and then the separating task of the pressure bonding between the rim 37 and the bead portion 35a is further supplementarily implemented from the front side.

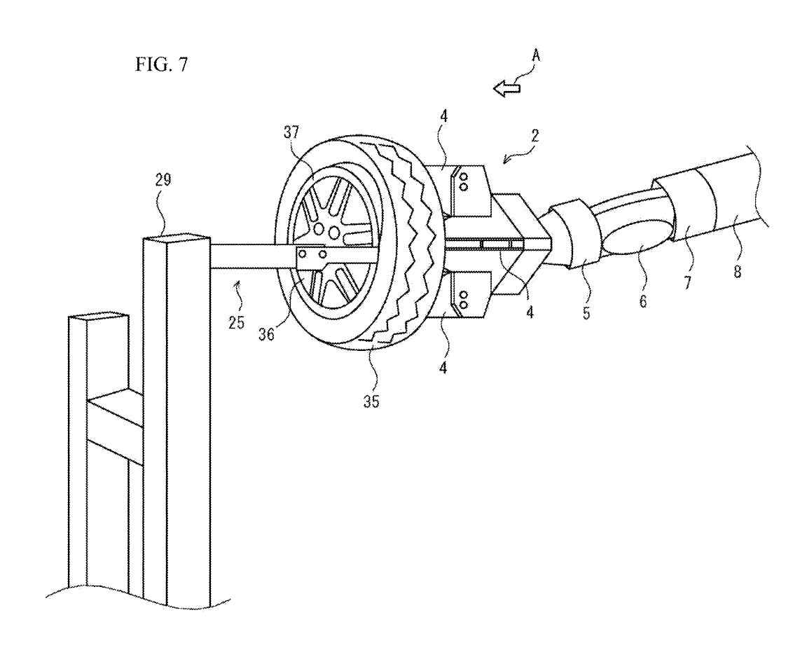

The reason thereof will be described later with reference to FIG. 7. When the bead portion 35a of the tire 35 is brought over the rim 37 to be removed to the outer side by using the insertion tool 25 afterwards, the insertion tool 25 is inserted from the front side. Thus, the complete separation is important for more easily progress of the step thereof. Further, performance of the task while releasing water or a solution made by dissolving a surfactant agent in water contributes to the subsequent step.

As shown in FIG. 6, the insertion tool 24 is inserted into the gap between the rim 37 and the tire 35 and water 38 is injected by the jetting nozzle 26 from the side of the insertion tool 24. In such a way, friction force can be lowered by injecting the water 38 or a surfactant aqueous solution, and generation of friction heat or damage to the tire and the wheel by the heat can be prevented.

In the present embodiment, this jetting nozzle 26 is provided in the vicinity of the insertion tool 24. However, the jetting nozzle 26 may be provided in the vicinity of the insertion tool 21 shown in FIG. 5 or may be provided in the vicinity of the insertion tool 25 as already described.

FIG. 7 is a concept view for illustrating a state where the bead portion 35a of the tire is brought over the rim of the front side wheel to be removed to the outer side by the insertion tool of the mounting/removing jig of the tire-mounting/removing system according to the second embodiment of the present invention.

In FIG. 7, the tire 35 in which both the pressure bonding between the front side and back side rims 37 of the wheel 36 and the bead portion 35a of the tire 35 are separated is moved in the direction of an arrow denoted by the reference sign A in such a manner that by an action of the second arm 8, the insertion tool 25 provided in the mount 29 is inserted into the gap between the rim 37 and the tire 35 from the front side of the wheel 36.

Posture control at the time is executed by controlling actions of any joints in addition to the fifth joint 6 and the fourth joint 7 of the second arm 8.

When the insertion tool 25 is inserted into the gap between the rim 37 and the tire 35, the bead portion 35a of the tire 35 is caught with the hook 25a of the flat-plate and long insertion tool 25. By rotating the head 2 in this state, the tire 35 can be pulled out to the front side of the wheel 36. By activating to pull the second arm 8 in the direction opposite to the direction of the arrow denoted by the reference sign A, the bead portion 35a can be more easily brought over the rim 37 of the wheel 36 and moved to the side of the mount 29.

The action can be executed entirely by turning the gripping hands 4 of the head 2 by the motor 3, and the front side bead portion 35a of the tire 35 is completely removed from the front side of the wheel 36.

However, it is highly possibly difficult to insert the insertion tool 25 from the front side and bring the back side bead portion 35a over the front side rim 37. Thus, in the embodiment of the present application, as shown in the following FIG. 8, the bead portion can be completely removed by utilizing and inserting the insertion tool 24 into the gap between the rim 37 and the bead portion 35a of the tire 35 from the back side in a state where only the front side bead portion 35a is brought over the rim 37 and removed from the front side of the wheel 36 by using the insertion tool 25.

FIG. 8 is a concept view for illustrating a state where the bead portion of the tire on the side of the back side wheel is removed from the rim of the front side tire by the insertion tool of the mounting/removing jig of the tire-mounting/removing system according to the second embodiment of the present invention. In FIG. 8, the insertion tool 24 is inserted from the gap between the tire 35 in such a posture that the back side of the wheel 36 is brought to face the insertion tool 24 by the second arm 8 and the back side rim 37. While receiving injection of the water 38 from the jetting nozzle 26, the head 2 is turned, the bead portion 35a is brought over the rim 37 of the front side wheel 36 over the entire circumference of the wheel 36, and the tire 35 is to be completely removed from the wheel 36. At the time, by pulling the second arm 8 in the direction of an arrow denoted by the reference sign B in the figure, force is applied to the far side in the figure from the insertion tool 24, and the tire 35 is operated to be removed from the wheel 36. That is, by bringing the opposite side bead portion 25a which is different from the one side bead portion 35a removed by the insertion tool 25 over the rim 37 on the side where the one side bead portion 25a is brought over, the insertion tool 24 also has a function of completely removing the tire 35 from the wheel 36.

The removed tire 35b completely removed from the wheel 36 is dropped onto the removed tire storage shed 28 straightaway, and stays at a position shown by broken lines.

After the tire 35 is removed, only the main body of the wheel 36 remains in the gripping hands 4. However, as described with reference to FIG. 3(a), the wheel 36 is continuously grasped. Thus, the wheel 36 can be conveyed to a desired and intended place by the tire-mounting/removing robot 1.

Further, after the wheel 36 is arranged at a predetermined position, the removed tire 35b temporarily placed in advance is collected and grasped above the removed tire storage shed 28 by the second arm 8, and conveyed to a desired and intended place by the tire-mounting/removing robot 1 as well as the wheel 36.

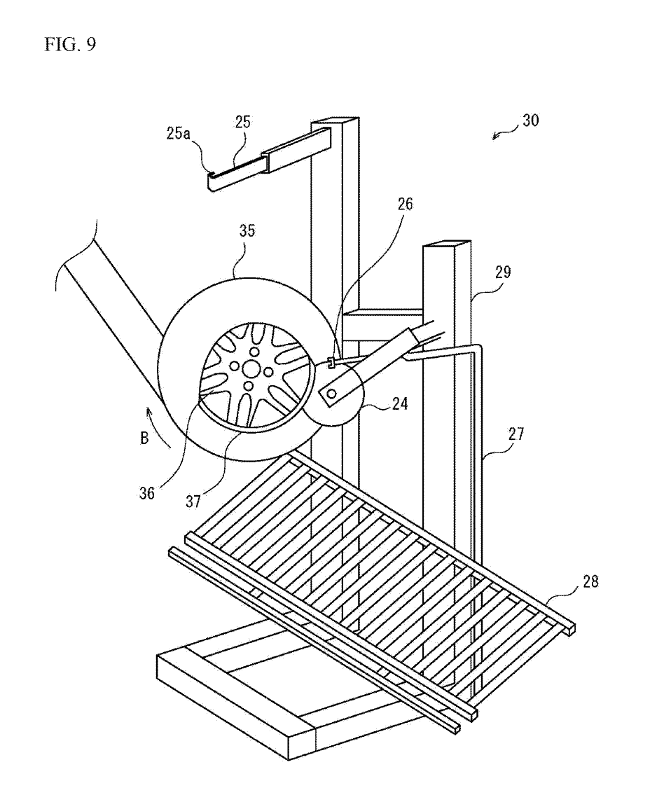

The step of removing the tire wheel 36 from the tire wheel-mounted tire is described above with reference to FIGS. 4 to 8. Next, with reference to FIG. 9, a step of mounting the tire wheel 36 in the tire wheel-non-mounted tire will be described.

FIG. 9 is a concept view for illustrating a state where the bead portion of the tire is brought over the rim of the front side wheel to the inner side to be mounted by the insertion tool of the mounting/removing jig of the tire-mounting/removing system according to the second embodiment of the present invention. In FIG. 9, the same components as the components shown in FIG. 6 will be given the same reference signs and description thereof will be omitted.

The tire wheel-non-mounted tire and the tire wheel 36 are away from each other. Firstly, a lubricant such as a surfactant agent is applied to the bead portion 35a of the tire wheel-non-mounted tire in advance by using the jetting nozzle 26 or other jigs. After the tire wheel-non-mounted tire is placed on a flat surface of the ground, a platform, etc., with the head 2 of the tire-mounting/removing robot 1, the edge portion 37a of the rim 37 of the wheel 36 is gripped by the claw portions 19 from any of the front side and the back side. While rotating the wheel 36 inclined by about 60 degrees with respect to the tire wheel-non-mounted tire, the rim 37 on the opposite side of the gripped rim 37 is brought in from an upper surface of the tire wheel-non-mounted tire. At the time, the head 2 is pushed by the tire-mounting/removing robot 1 to push the wheel 36 in.

After that, as shown in FIG. 9, the one side rim 37 (rim 37 on the opposite side of the gripped rim 37) of the wheel 36 is brought into the inner side of the tire wheel-non-mounted tire. In a state where the tire main body 35 is locked onto the rim 37, the head 2 of the tire-mounting/removing robot 1 moves to the insertion tool 24 of the mounting/removing jig 30 of the tire-mounting/removing system. FIG. 9 shows a case where the head 2 of the tire-mounting/removing robot 1 grips the edge portion 37a of the rim 37 of the wheel 36 from the back side by the claw portions 19.

After that, while inserting the bead portion 35a on the lower surface side by the insertion tool 24 in such a manner that the bead portion 35a on the lower surface side of the tire wheel-non-mounted tire is placed on the inner side of the rim 37 of the front side wheel 36 which is not grasped by the claw portions 19, by rotating the head 2 in the direction denoted by the reference sign B again, the bead portion 35a can be brought into the inner side of the rim 37 all over the circumferential direction, so that the wheel 36 can be mounted in the tire wheel-non-mounted tire. By injecting air in this state, air pressure of the tire can be boosted, and the tire can function as a tire. Therefore, there is no need for using the insertion tool 25 in the mounting step.

As already described, the insertion tool 21 may be used instead of the insertion tool 24.

When serving only for removal of the wheel 36, the first claw portion 19a of the claw portion 19 only has a function of simply locking the rim 37. However, in a case where the first claw portion 19a has a function of mounting the wheel 36, a gap with the second claw portion 19b is desirably formed to grasp the edge portion 37a of the rim 37 of the wheel 36. That is, the edge portion 37a is nipped by the first claw portion 19a and the second claw portion 19b. This is because there is a need for an operation of pushing the wheel 36 into the tire wheel-non-mounted tire in a gripped state and pushing cannot be performed only by locking.

With the tire-gripping head 2 according to the third embodiment of the present invention, as shown in FIG. 3(a), the first claw portion 19a formed in the end portion of the claw portion 19 is formed in a thin plate shape so as to be easily inserted into the gap between the rim 37 of the wheel 36 and the bead portion 35a of the tire main body 35. The second claw portion 19b formed in the root portion of the claw portion 19 is formed to be thicker than the first claw portion 19a and furthermore bent to form a dog-leg shape with the first claw portion 19a. The rim 37 of the wheel 36 can be guided to and grasped by a recess portion formed by the bending.

By the series of working steps described above, the spent or used tire can be grasped by the head 2 of the tire-mounting/removing robot 1, and in that state, the wheel 36 and the tire 35 can be removed and mounted by using the insertion tools 21, 24, 25. At the time, by detecting the rotation angles of the servomotors that drive the joints and the gripping hands 4 of the head 2 forming the tire-mounting/removing robot 1 by the encoder 14, the rotation angles can be digitally controlled. Thus, the spent or used tire can be treated fully automatically.

By using such a tire-mounting/removing system, particularly the removing task of the wheel 36 and the tire 35 which has been performed by a plurality of workers can be performed by the robot instead. Thus, labor and time can be saved, and the task with high efficiency and precision can be realized.

Furthermore, in a series of tasks of the spent or used tire recycling business, the step left behind can be automated, and automation of the entire business can also be realized.

When including the configuration shown in the specification of the present application and the drawings, for example, the tire-mounting/removing robot can be activated remotely manually. However, a manual operation performed by human being takes time for performing a series of actions, and working efficiency is highly possibly lowered.

In order to increase efficient movement, by appropriately combining the already developed and known techniques such as control of correcting the rotation angles of the servomotors for example by using an image sensor to process images of the image sensor and recognize the position, and efficiency improvement by using feedback control for the posture control by using a sensor capable of reading the position, a large number of spent or used tires can be mounted and removed in a shorter time.

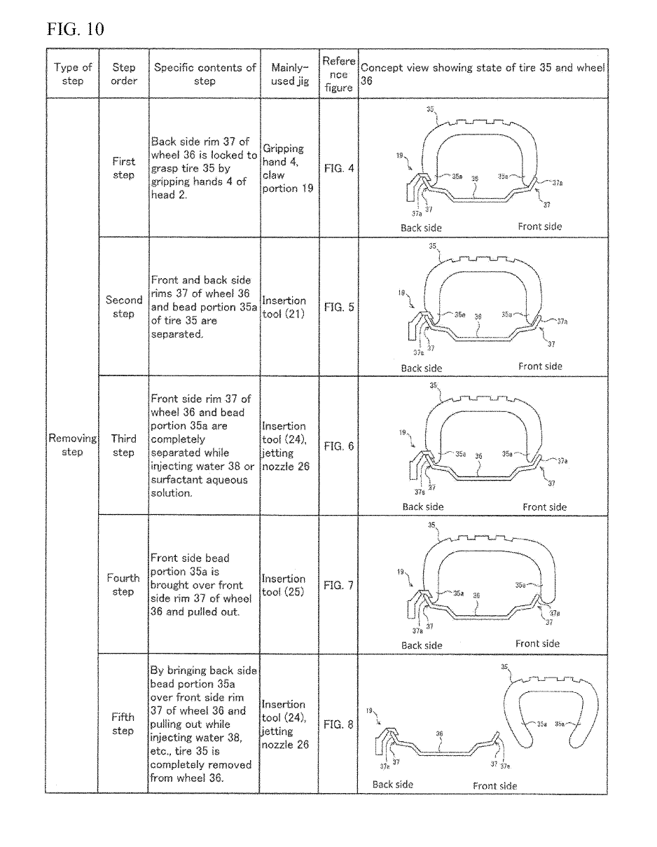

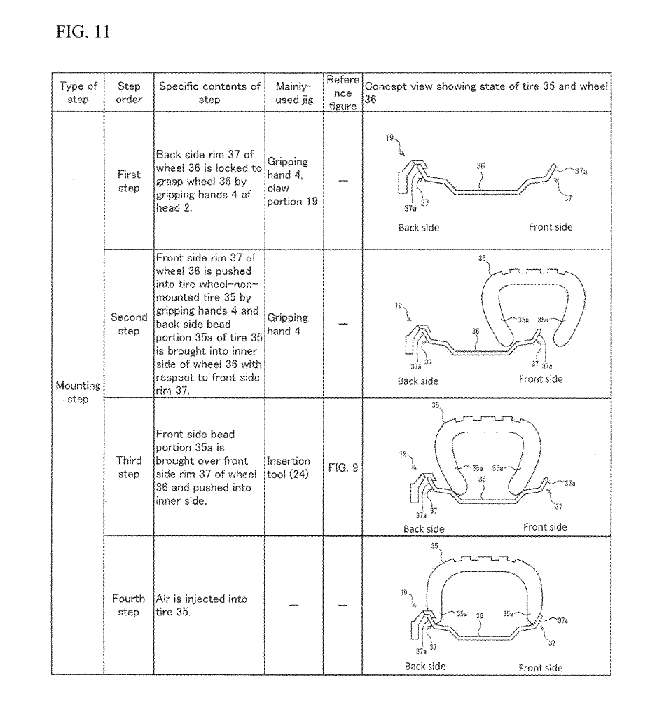

Finally, with reference to FIGS. 10 and 11, the actions of the tire-mounting/removing system according to the present embodiment will be summed up.

FIGS. 10 and 11 show specific contents of steps among the already described actions of the tire-mounting/removing system along the order in the step of the removing step and the mounting step, respectively. The drawing corresponding to a state of each step is shown by the number, and a simple concept view is provided for clarifying a positional relationship between the bead portion 35a and the rim 37 of the tire 35 and the wheel 36 in the series of steps.

In FIG. 10, a first step in the removing step is a step of locking the back side rim 37 of the wheel 36 to grasp the tire 35 by using the claw portions 19 and the gripping hands 4 of the head 2. In this step, the front and back side rims 37 of the wheel 36 and the bead portion 35a are not separated yet.

A second step is a step of separating the front and back side rims 37 of the wheel 36 and the bead portion 35a of the tire 35 by using the insertion tool 21. In this step, the front and back side rims 37 of the wheel 36 and the bead portion 35a are separated.

A third step is a step of completely separating the front side rim 37 of the wheel 36 and the bead portion 35a while injecting the water 38 or a surfactant aqueous solution by using the insertion tool 21 and the jetting nozzle 26. This third step can be omitted when the front side rim 37 of the wheel 36 is completely separated in the second step. The rim may be separated while jetting the water 38 or a surfactant aqueous solution by using the jetting nozzle 26 in the second step. As long as the insertion tools 21, 24 are formed in a flat disc shape, any insertion tools may be used. Two types of insertion tools are not necessarily provided and not a pair of insertion tools is required unlike the insertion tools 21.

A fourth step is a step of bringing the front side bead portion 35a over the front side rim 37 of the wheel 36 and pulling out by the insertion tool 25. Since the hook 25a is provided in the leading end portion of the insertion tool 25, by catching this hook 25a onto the bead portion 35a and pulling the wheel 36 in the direction going away from the insertion tool 25 while rotating the gripping hands 4, the bead portion 35a can be completely removed from the front side rim 37 of the wheel 36. The bead portion 35a may also be separated or pulled out while jetting water or a surfactant aqueous solution in this fourth step.

A fifth step is a step of completely removing the tire 35 from the wheel 36 by bringing the back side bead portion 35a over the front side rim 37 of the wheel 36 and pulling out while injecting the water 38, etc. In this fifth step, since the tire 35 is removed from the wheel 36, the tire 35 is dropped off the gripping hands 4. Therefore, the task is desirably performed in an area where the tire can be dropped. As described with reference to FIG. 8, a place or a device for receiving the drop-off tire such as the removed tire storage shed 28 is desirably ensured.

Next, the mounting step will be described with reference to FIG. 11.

A first step is a step of locking the back side rim 37 of the wheel 36 to grasp the wheel 36 by using the claw portions 19 of the gripping hands 4 of the head 2.

A second step is a step of pushing the front side rim 37 of the wheel 36 into the tire wheel-non-mounted tire 35 by the gripping hands 4 and bringing the back side bead portion 35a of the tire 35 into the inner side of the wheel 36 with respect to the front side rim 37.

Further, a third step is a step of now bringing the front side bead portion 35a over the front side rim 37 of the wheel 36 from this state of the second step and bringing the bead portion 35a into the inner side. Thereby, both the bead portions 35a of the tire 35 are brought into a position near center of the wheel 36 between the two rims 37 of the wheel 36. By injecting air into the tire 35 from this state in a fourth step, air pressure in the tire 35 is boosted.

The action of the tire-mounting/removing system described with reference to FIG. 10 is to lock the back side rim 37 of the wheel 36 to grasp the wheel 36 by the claw portions 19 of the hands 4 in any of the removing step and the mounting step. However, the front side rim 37 may be locked to grasp the wheel 36.

### INDUSTRIAL APPLICABILITY

As described above, the inventions according to claims 1 to 7 of the present invention can be utilized for the spent or used tire recycling business as a matter of course, and further, also utilized for the time when a private automobile plant or an automobile dealer performs automobile inspection of a customer's automobile, replacement of winter tires, and general maintenance.

### DESCRIPTION OF REFERENCE SIGNS

1: Tire-mounting/removing robot
2: Head
3: Motor
4: Gripping hand
5: Sixth joint
6: Fifth joint
7: Fourth joint
8: Second arm
9: Motor
10: Third joint
11: First arm
12: Power source and signal cable
13: Second joint
14: Encoder
15: Power source terminal
16: Motor
17: Base
18: First joint
19: Claw portion
19a: First claw portion
19b: Second claw portion
20: Mounting/removing jig
21: Insertion tool
22: Support plate
23: Mount
24: Insertion tool
25: Insertion tool
25a: Hook
26: Jetting nozzle
27: Water injection pipe
28: Removed tire storage shed
29: Mount
30: Mounting/removing jig
31: Treatment tire storage shed
32: Side surface roller
33: Bottom surface roller
34: Mount
35: Tire
35a: Bead portion
35b: Removed tire
36: Wheel
37: Rim
37a: Edge portion
38: Water
40: Driving screw
41: Driven side timing pulley
42: Drive side timing pulley
43: Timing belt
44: Nut
45: Linear movement coupling link plate
45a: Shaft
45b: Shaft
46: Parallel link bar
47: Open/close shaft

1. A tire-gripping head comprising:
a hand portion that grips a tire or a tire wheel; and
a mechanism that opens and closes the hand portion,
wherein the hand portion includes a claw portion in an end portion of the hand portion, and
the claw portion includes a first claw portion to be locked onto an edge portion of a rim of the tire wheel to grasp the tire wheel or a tire wheel-mounted tire in which the tire wheel is mounted, and a second claw portion to be locked onto a bead portion of a tire wheel-non-mounted tire to grasp the tire wheel-non-mounted tire.

2. The tire-gripping head according to claim 1, wherein
the mechanism that opens and closes the hand portion includes a screw shaft, a nut to be screwed onto the screw shaft, a first pulley provided in the screw shaft, a belt looped over the first pulley, a second pulley over which the belt is looped, and a drive motor that turns the second pulley,
the hand portion is engaged with the nut, and
the hand portion is opened and closed by movement of the nut in accordance with rotation of the screw shaft.

3. A tire-mounting/removing robot, wherein
the tire-gripping head according to claim 1 is mounted in a leading end of an arm.

4. A tire-mounting/removing system comprising:
the tire-mounting/removing robot according to claim 3; and
a tire-mounting/removing jig for removing the tire wheel from the tire wheel-mounted tire, wherein
the tire-mounting/removing jig has:
a first insertion tool to be inserted into a gap between the rim of the tire wheel of the tire wheel-mounted tire and the bead portion of the tire to separate the rim and the bead portion in a state where the first claw portion of the hand portion is put into the gap between the rim and the bead portion of the tire and locked onto the edge portion of the rim and the hand portion grasps the tire wheel-mounted tire; and
a second insertion tool to be inserted into the gap between the rim and the bead portion which are separated by the first insertion tool to bring the bead portion (35a) of the tire arranged on an inner side of the rim of the tire wheel over the rim of the tire wheel and remove the bead portion to an outer side of the rim.

5. The tire-mounting/removing system according to claim 4, wherein
the tire-mounting/removing robot pushes a rim on an opposite side to a side where the first claw portion grasps the tire wheel into the bead portion on one side of the tire wheel-non-mounted tire in a state where the first claw portion of the hand portion is locked onto the edge portion of the rim of the tire wheel to grasp the tire wheel, and
the first insertion tool, by inserting a bead portion on the other side of the tire wheel-non-mounted tire into the inner side of the rim on the opposite side, mounts the tire wheel in the tire wheel-non-mounted tire.

6. The tire-mounting/removing system according to claim 4, wherein
a water injection port is provided in the vicinity of at least one of the first insertion tool and the second insertion tool, and water or a surfactant aqueous solution is injectable when the first insertion tool or the second insertion tool is inserted into the gap between the rim of the tire wheel and the bead portion of the tire.

7. The tire-mounting/removing system according to claim 4, wherein
a removed tire storage shed on which the removed tire is mountable is provided in the vicinity of the first insertion tool or the second insertion tool.

8. A tire-mounting/removing robot, wherein
the tire-gripping head according to claim 2 is mounted in a leading end of an arm.

9. The tire-mounting/removing system according to claim 5, wherein
a water injection port is provided in the vicinity of at least one of the first insertion tool and the second insertion tool, and water or a surfactant aqueous solution is injectable when the first insertion tool or the second insertion tool is inserted into the gap between the rim of the tire wheel and the bead portion of the tire.

10. The tire-mounting/removing system according to claim 5, wherein
a removed tire storage shed on which the removed tire is mountable is provided in the vicinity of the first insertion tool or the second insertion tool.

11. The tire-mounting/removing system according to claim 6, wherein
a removed tire storage shed on which the removed tire is mountable is provided in the vicinity of the first insertion tool or the second insertion tool.
